(19) United States
(12) Patent Application Publication
(10) Pub. No.: US 2013/0117066 A1
(43) Pub. Date: May 9, 2013

(54) DECISION SUPPORT METHOD AND SYSTEM FOR PROJECT MANAGEMENT OF LIQUEFIED NATURAL GAS PLANT

(71) Applicants: HWAN-PYO PARK, GYEONGGI-DO (KR); KYUNG-HO CHIN, INCHEON (KR); JAE-GOO HAN, GYEONGGI-DO, (KR)

(72) Inventors: HWAN-PYO PARK, GYEONGGI-DO (KR); KYUNG-HO CHIN, INCHEON (KR); JAE-GOO HAN, GYEONGGI-DO, (KR)

(73) Assignee: KOREA INSTITUTE OF CONSTRUCTION TECHNOLOGY, GYEONGGI-DO (KR)

(21) Appl. No.: 13/447,281

(22) Filed: Apr. 15, 2012

(30) Foreign Application Priority Data
Nov. 8, 2011 (KR) 10-2011-0115900

(51) Int. Cl. G06Q 10/06

(52) U.S. Cl. 705/7.28

(57) ABSTRACT

Provided are a decision support method and system for project management of a LNG plant. In the decision support method, a plurality of stages corresponding to sequential processes performed for Engineering, Procurement & Construction project management of the LNG plant are determined Decision items necessary to perform each of the plurality of stages are determined. Individual performance scores with respect to the decision items are estimated and a total performance score with respect to each of the plurality of stages is determined using the individual performance scores. Risk factors with respect to each of the plurality of stages are determined and risk indexes with respect to each of the plurality of stages are derived by evaluating the risk factors. Decision-making is performed with respect to a corresponding stage according to the total performance score and the risk index derived with respect to each of the plurality of stages.

### CROSS-REFERENCE TO RELATED APPLICATIONS

This U.S. non-provisional patent application claims priority under 35 U.S.C. §119 of Korean Patent Application No. 10-2011-0115900, filed on Nov. 8, 2011, the entire contents of which are hereby incorporated by reference.

### BACKGROUND

The present invention herein relates to a decision support method and system for a liquefied natural gas (LNG) plant business, and more particularly, to a decision support method and system that utilizes a stage-gate model for Engineering, Procurement and Construction (EPC) project management of an LNG plant.

Recently, LNG has been receiving attention as a new form of energy. Due to the steadily increasing demand in the LNG market, orders for large-scale LNG plants by LNG producing nations have been increasing. Accordingly, domestic construction companies are developing various technologies to advance to the Engineering, Procurement & Construction (EPC) market, which, along with construction, is a highly valued field for the LNG plant market.

Similarly to other large-scale construction business, overall business stages including planning, design, purchase & procurement, construction & test run, and management & maintenance are collectively performed in the LNG plant construction business. In order for enterprises to advance to the LNG plant construction business, it is necessary to accumulate construction experience and know-how and secure management techniques from systematic technical standards and procedures related to the corresponding business as well as design & construction technologies including process technology.

The decision is a conscious process for selecting an optimal solution from one or more alternatives to achieve goals such as a desirable state. Accordingly, the decision is made so as to maximize profits of a decision-maker and minimize losses of the decision-maker. The behavior decision-making is difficult because it is diversified according to the value, knowledge, and experience of an evaluator together with complexity, uncertainty, and various selection criteria of the problem structure. A process of a typical decision is shown in FIG. 1.

FIG. 1 is a flowchart illustrating a typical decision process.

Referring to FIG. 1, a typical decision process includes recognizing and analyzing a problem (S1), defining a target (S2), deriving an alternative (S3), making a decision (S4), selecting a strategy to be applied (S5), and evaluating and providing feedback (S6).

However, domestic construction companies, which are latecomers to the LNG plant construction business, have relatively deficient abilities in project management compared to foreign advanced LNG plant construction companies. Accordingly, various decision support methods for domestic construction companies having deficient abilities in the LNG plant construction business are needed to secure project management ability in a short time.

### PRIOR ART

### Patent Reference

(Patent Reference 0001) 1) Korean Patent No. 10-1069202 (filed on Dec. 29, 2009), Title: “Optimal information processing method of LNG plant and apparatus supporting the same”

(Patent Reference 0002) 2) Korean Patent No. 10-1052585 (filed on Dec. 29, 2009), Title: “System for supporting LNG plant and user interface thereof”

### SUMMARY

The present invention provides a decision support method and system for a liquefied natural gas (LNG) plant business, which can derive an alternative with a structured system and achieve a decision structure based on risk by combining logical decision structure and procedure of the business performance process with a project management decision support system for an LNG plant business.

The present invention also provides a decision support method and system for an LNG plant business, which can supplement general project management ability and minimize design and construction errors and reworking by supporting a decision using a stage-gate model in which a point when the decision is necessary is defined as a gate in Engineering, Procurement & Construction (EPC) project management for an LNG plant business.

According to embodiments of the present invention, a decision support method for project management of an LNG plant, includes: determining a plurality of stages corresponding to sequential processes performed for EPC project management of the LNG plant; determining decision items necessary to perform each of the plurality of stages; estimating individual performance scores with respect to the decision items and deriving a total performance score with respect to each of the plurality of stages using the individual performance scores; determining risk factors with respect to each of the plurality of stages and deriving risk indexes with respect to each of the plurality of stages by evaluating the risk factors; and performing decision-making with respect to a corresponding stage according to the total performance score and the risk index derived with respect to each of the plurality of stages.

In some embodiments, the determining of the decision items may include determining the decision items based on compatibility with strategic goals, compatibility with investment return goals, compatibility with safety standards, and compatibility with quality standards.

In other embodiments, the individual performance scores may include a strategy score assigned to the decision item related to the compatibility with the strategic goal, a cost score assigned to the decision item related to the compatibility with the investment returns goal, a safety score assigned to the decision item related to the compatibility with the safety standards, and a quality score assigned to the decision item related to the compatibility with the quality standards.

In still other embodiments, the deriving of the total performance score may include determining a value obtained by multiplying arithmetic mean values of the strategy scores, the cost scores, the safety scores, and the quality scores by predetermined importance indexes and adding them together as the total performance score.

In yet other embodiments, the determining of the risk factors may include determining the risk factors using a PI score that is a relative priority of a risk estimated using probability and impact of the risk factor. Here, the PI score is \sqrt{P²+I²}, where P may denote the probability of the risk factor, I may denote the impact of the risk factor, and the risk index may be determined in accordance with the PI score.

In yet other embodiments, the performing of the decision-making may include: dividing all values that the total performance score and the risk index have into a plurality of sections and determining a type of decision linked to the total performance score and the risk index for each section; and performing a type of decision determined with respect to a section to which the total performance score derived in the deriving of the total performance score and the risk index derived in the determining of the risk factors belong.

In yet other embodiments, the determining of the type of decision may include: dividing all values that the total performance score has and all values that the risk index has into first to third sections having a uniform size, wherein the total performance score or the risk index is reduced from the first section to the third section; making a decision to rework a corresponding stage when the total performance score corresponds to the second section or the third section and the risk index corresponds to the first section; making a decision to perform risk reduction and avoidance activities when the total performance score corresponds to the first section and the risk index corresponds to the first section; making a decision to perform reworking on design performance when the total performance score corresponds to the third section and the risk index corresponds to the second section or the third section; and making a decision to progress to a next stage in sequential processes when the total performance score corresponds to the first section or the third section and the risk index corresponds to the second section or the third section.

According to other embodiments of the present invention, a decision support system for project management of a LNG plant includes: a business information management part configured to determine a plurality of stages corresponding to sequential processes performed for EPC project management of the LNG plant, decision items necessary to perform each of the plurality of stages, and risk factors with respect to each of the plurality of stages; a decision item evaluation part configured to estimate individual performance scores with respect to the decision items and derive a total performance score with respect to each of the plurality of stages using the individual performance scores; a risk factor evaluation part configured to derive risk indexes with respect to each of the plurality of stages by evaluating the risk factors; and a decision part configured to perform decision-making with respect to a corresponding stage according to the total performance score and the risk index derived with respect to each of the plurality of stages.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a typical decision process;

FIG. 2 is a flowchart illustrating a decision support method for project management of an LNG plant according to an embodiment of the present invention;

FIG. 3 is a view illustrating sequential process stages for project management of an LNG plant determined in a process of determining a plurality of stages shown in FIG. 2;

FIG. 4 is a view illustrating a decision logic on a gate of a stage-gate model for EPC project management of an LNG plant according to an embodiment of the present invention;

FIG. 5 is a view illustrating decision items determined in a process of determining the decision items shown in FIG. 2;

FIG. 6 is a view illustrating estimation of the total performance score in a process of deriving the total performance score shown in FIG. 2;

FIG. 7 is a view illustrating estimation of a biaxial risk level for deriving a risk index in a process of deriving the risk index shown in FIG. 2;

FIG. 8 is a view illustrating a decision method performed in a process of performing decision-making shown in FIG. 2;

FIG. 9 is a view illustrating a decision support system for project management of an LNG plant according to an embodiment of the present invention; and

FIGS. 10a through 10c are views illustrating web screens of a decision support system for project management of an LNG plant according to an embodiment of the present invention.

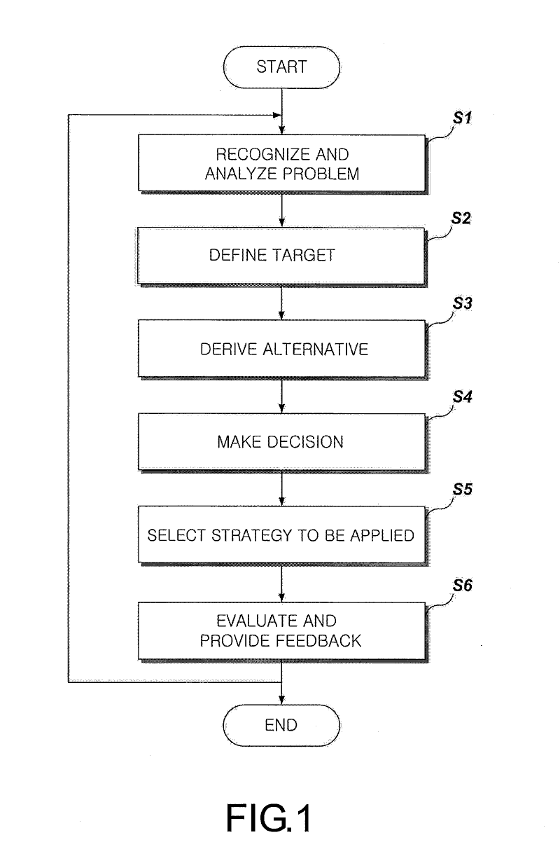

### DETAILED DESCRIPTION OF THE EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this invention will be thorough and complete, and will fully convey the scope of the present invention to those skilled in the art.

Hereinafter, exemplary embodiments of the present invention will be described in detail with reference to the accompanying drawings.

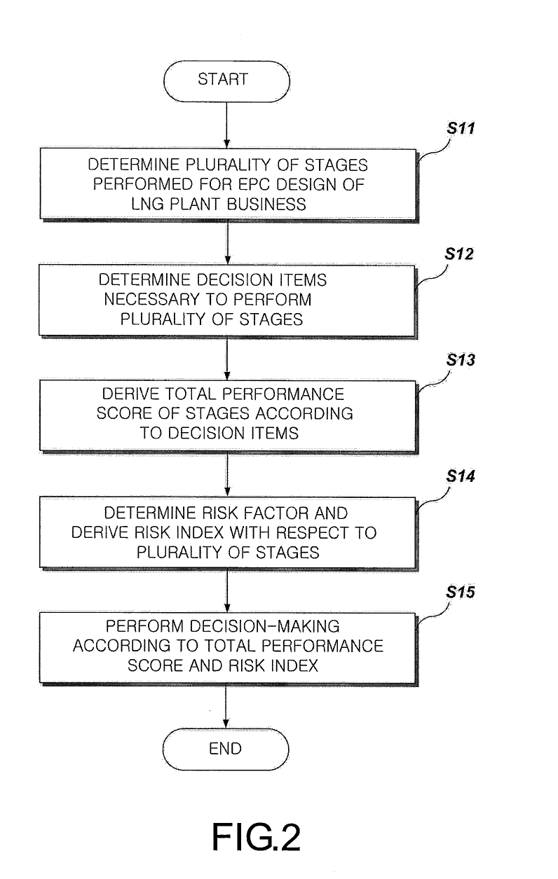

FIG. 2 is a flowchart illustrating a decision support method for project management of a liquefied natural gas (LNG) plant according to an embodiment of the present invention.

Referring to FIG. 2, a decision support method for project management of a LNG plant according to an embodiment of the present invention may include determining a plurality of stages corresponding to sequential processes performed for Engineering, Procurement & Construction (EPC) project management of an LNG plant (S11); determining decision items necessary to perform each of the plurality of stages (S12); estimating individual performance scores with respect to the decision items and deriving a total performance score with respect to the plurality of stages using the individual performance scores (S13); determining risk factors with respect to the plurality of stages and evaluating the risk factors to derive a risk index with respect to the plurality of stages (S14); and performing decision-making with respect to a corresponding stage according to the total performance score and the risk index derived with respect to the plurality of stages.

In this embodiment, modeling may be performed for design of the EPC business using a stage-gate model that can be easily applied to existing nonrepetitive and development-oriented businesses as a model utilizable for a decision process in consideration of the characteristics of the EPC project management of an LNG plant. For this, in this embodiment, the determining of the plurality of stages (S11) corresponding to the sequential processes performed for the EPC project management of an LNG plant may be first performed.

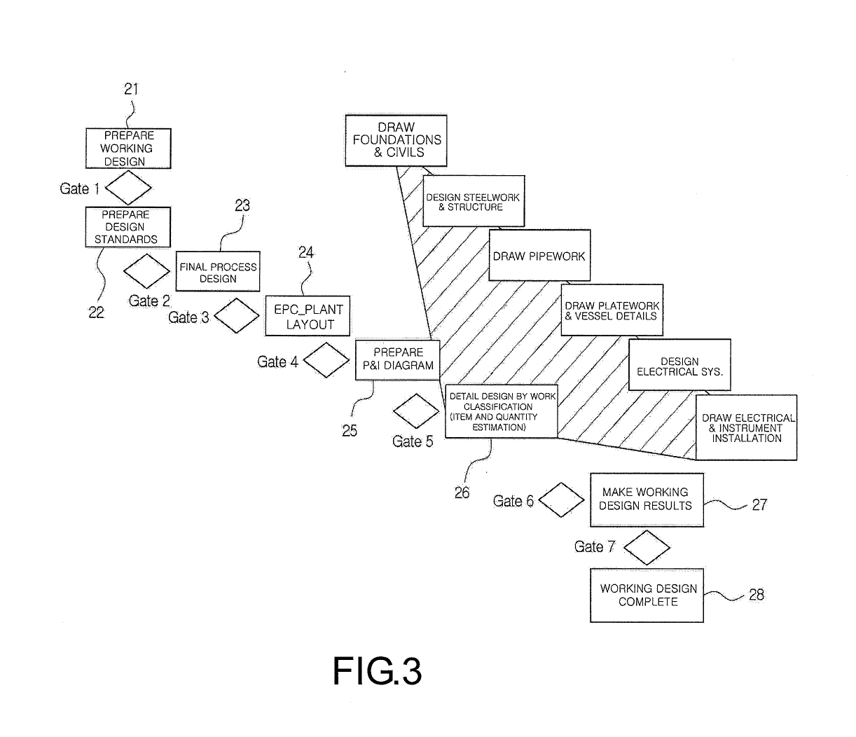

FIG. 3 is a view illustrating sequential process stages for project management of an LNG plant determined in a process of determining a plurality of stages shown in FIG. 2.

As shown in FIG. 3, the EPC business design of the LNG plant business may include a total of eight stages 21 to 28, and gates 1 to 7 may be provided between the stages 21 to 28 to determine whether to progress to a next stage.

The decision using the gates 1 to 7 provided between the stages 21 to 28 may include deriving a performance score with respect to the project management and deriving a risk index in terms of risk.

In operations S12 and S13, the performance score may be derived in terms of the project management using the gates 1 to 7 between the stages 21 to 28 after the plurality of stages are determined in operation S11.

In operation S12, decision items may be determined in terms of the project management necessary to perform the plurality of stages. Specifically, in operation S12, the decision items may be determined based on compatibility with strategic goals, compatibility with investment return goals, compatibility with safety standards, and compatibility with quality standards that are fundamental decision evaluation items of the EPC business of the LNG plant.

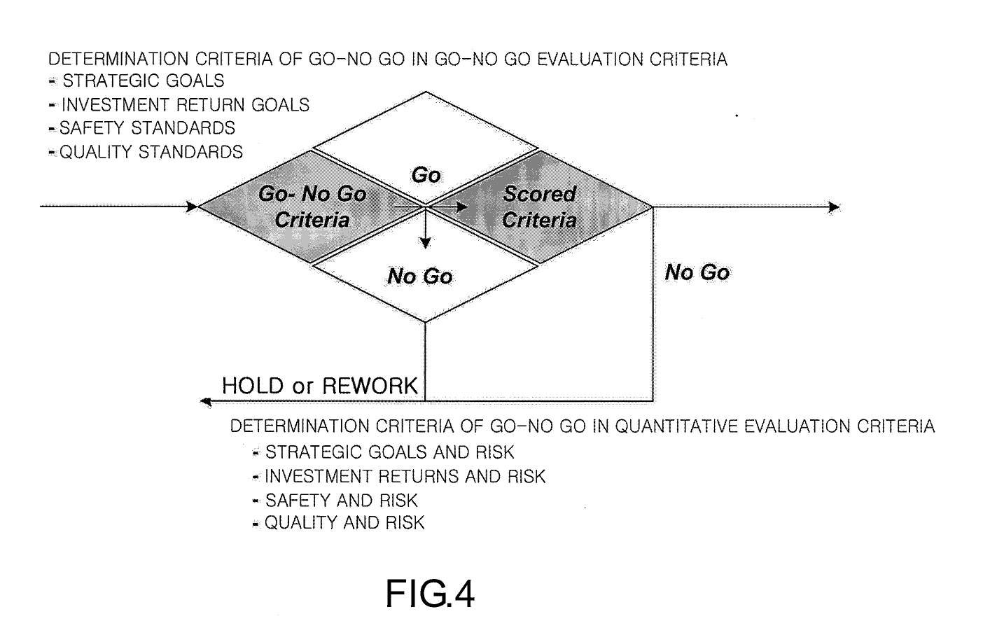

FIG. 4 is a view illustrating a decision logic on a gate of a stage-gate model for EPC project management of an LNG plant according to an embodiment of the present invention.

In the decision logic for implementing the decision support system for the LNG plant business, a decision may be performed by configuring gate review factors and dividing them into a Go-No Go subgate, and a scored subgate according to the risk and management level score, as shown in FIG. 4, based on the compatibility with strategic goals, the compatibility with investment return goals, the compatibility with safety standards, and the compatibility with quality standards that are the fundamental decision evaluation items.

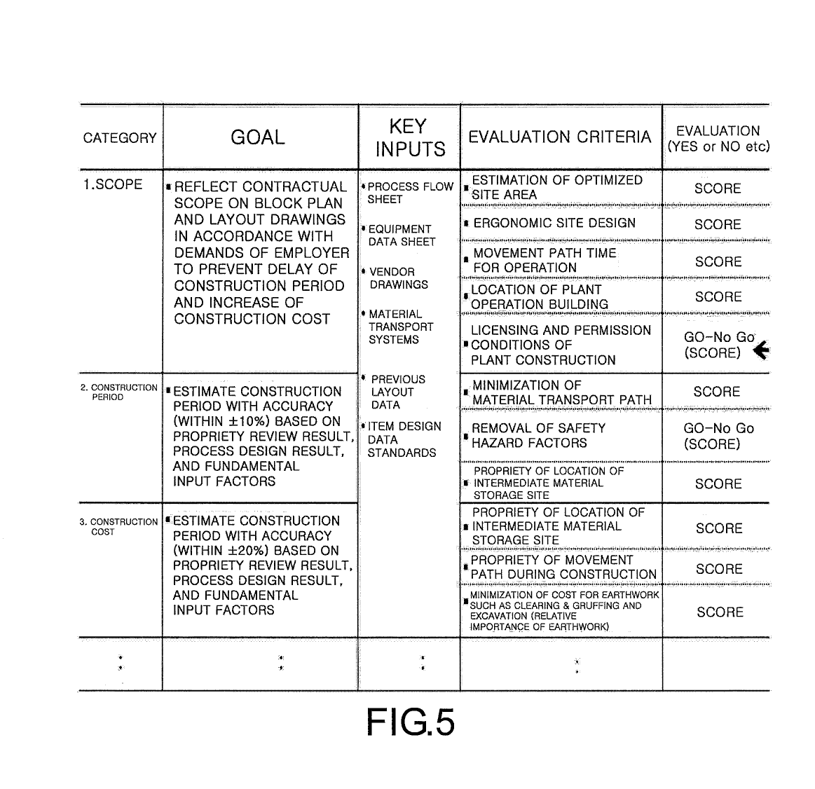

FIG. 5 is a view illustrating decision items determined in a process of determining the decision items determined in operation S12. Referring to FIG. 5, the decision items may be roughly divided into scope, value for money, project integration, and technology requirements, and may be determined such that detailed evaluation criteria are proposed for detailed decision items to enable quantitative evaluation.

If the decision items are determined in operation S12, then individual performance scores may be estimated with respect to the decision items, and the total performance score may be derived with respect to the plurality of stages using the individual performance scores in operation S13.

Here, the individual performance scores, which are estimated with respect to each decision item, may include performance scores related to the compatibility with strategic goals, the compatibility with investment return goals, the compatibility with safety standards, and the compatibility with quality standards that are the fundamental decision evaluation items of the EPC business of the LNG plant. Specifically, when the decision items are related to the compatibility with strategic goals, a strategy score may be estimated, and when the decision items are related to the compatibility with investment return goals, a cost score may be estimated. Also, when the decision items are related to the compatibility with safety standards, a safety score may be estimated, and when the decision items are related to the compatibility with quality standards, a quality score may be estimated.

The individual performance scores estimated in the above process may be averaged by the type of the individual performance scores, and then the total performance score may be determined using the average scores.

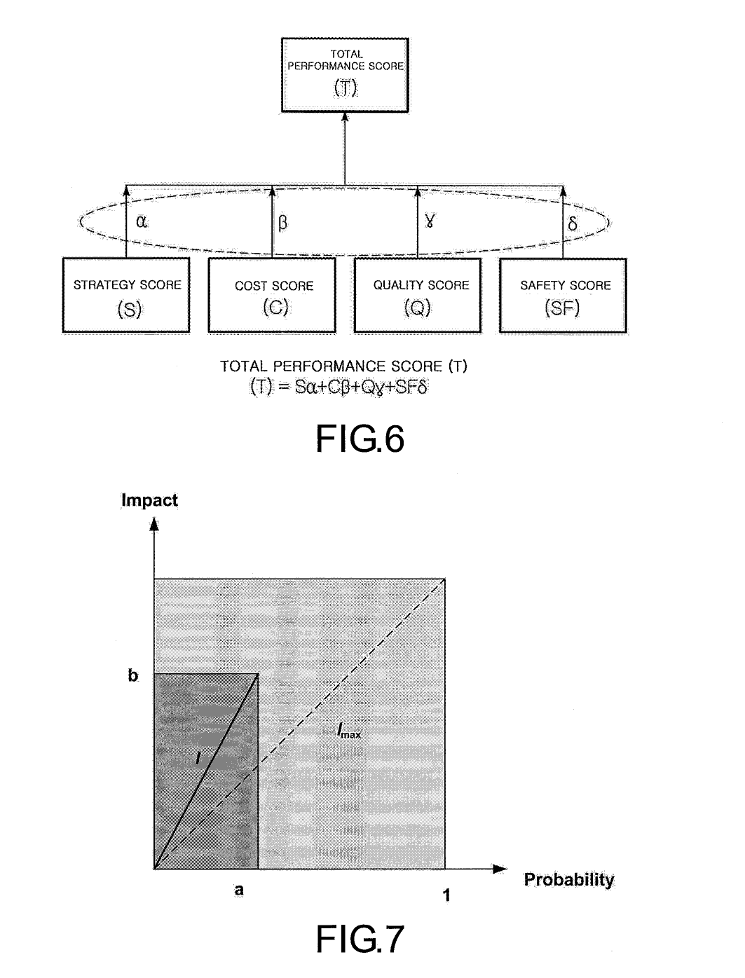

FIG. 6 is a view illustrating the concept of estimation of the total performance score.

As shown in FIG. 6, arithmetic mean values (S, C, Q, and SF) of the respective strategy scores, cost scores, quality scores, and safety scores among the performance scores may be multiplied by predetermined importance indexes (α, β, γ, and δ) and added together to determine the total performance score (T).

After the plurality of stages are determined in operation S11, the risk index may be derived in terms of risk using the gates between the stages in operation S14.

In operation S14, the risk factors may be determined with respect to the plurality of stages determined in the process for the project management of the LNG plant, and the risk factors may be evaluated to derive the risk indexes with respect to the plurality of stages.

Compared to typical construction projects, the LNG plant business requires detailed risk evaluation due to its complexity and diversity. Also, since recent overseas LNG plant businesses require more complex technology and management, a risk evaluation system reflecting the complex technology and management may be needed. Accordingly, in operation S14 of the this embodiment, a stage-gate model may be used to apply a three-step risk evaluation management system including evaluating the priority of a risk by each stage for the project management of the LNG plant, dealing with and managing the risk, and monitoring the risk.

FIG. 7 is a view illustrating estimation of a biaxial risk level for deriving a risk index in a process of deriving the risk index shown in FIG. 2.

Referring to FIG. 7, a method of determining a biaxial risk priority in which two axes, probability and impact, are used to determine the priority of the risk may be used in this embodiment. In other words, a system of evaluating risks at a point when each stage is finished using a stage-gate process model for project management of an LNG plant may be provided in this embodiment.

Specifically, using one of methods widely used for derivation of the risk priority, evaluation may be performed by applying a distance concept with two criteria, probability and impact. In this case, the distance concept may include defining both axes of a rectangular coordinate system based on the origin as probability and impact to calculate a distance from the origin and evaluate the level of the risk. Accordingly, the relative priority of a risk may be expressed as Equation (1), which is called a PI score.

Relative Priority of Risk=\sqrt{P²+I²} (1)

where P denotes a probability of the risk factor, and I denotes an impact of the risk factor.

The biaxial evaluation technique may be expressed as a risk matrix that serves to easily distinguish the level of the risk. Also, since the biaxial evaluation technique has an advantage in that the level of a corresponding risk can be easily understood immediately after the location of the risk is identified, the biaxial evaluation technique is being widely used as a risk evaluation method.

In this embodiment, the priority of the risk may be derived by the biaxial (PI) method in order to increase practical application. When a user inputs probability (P) and impact (I) of an individual risk factor as one point (very low) to five points (very high), the relative priority score of the risk factor by stage may be derived by Equation (1), and the risk index corresponding thereto may be determined.

Next, in operation S15, a decision may be performed on a corresponding stage using the total performance score and the risk index derived with respect to the plurality of stages through the above processes.

In operation S15, the decision may be performed by linking the total performance score derived from the evaluation on the project management activities of the LNG plant with the risk index derived from the risk management activities that are separately performed.

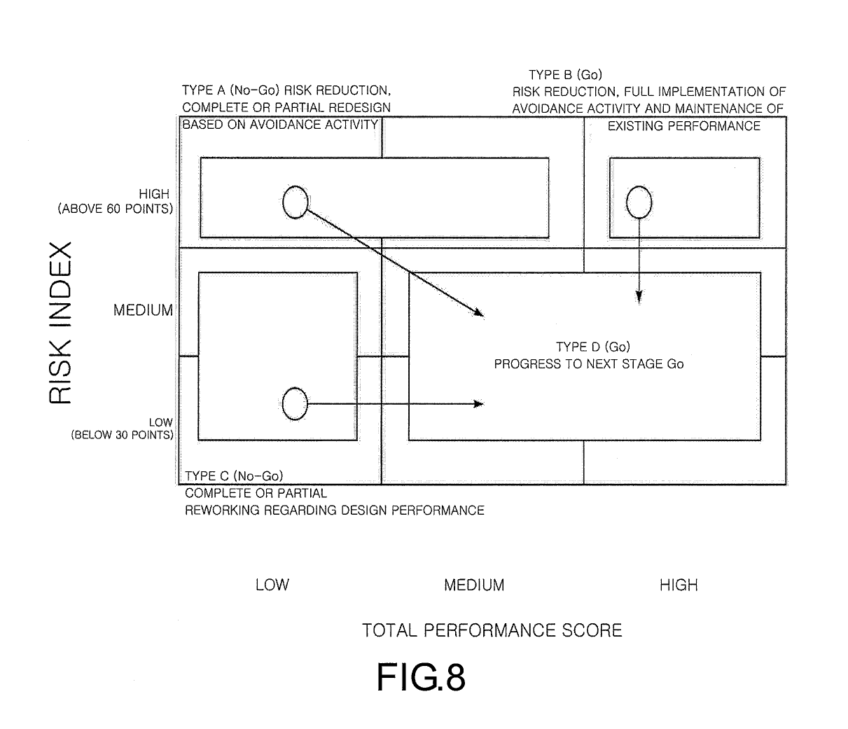

More specifically, in operation S15, all values that the total performance score and the risk index can have may be divided into a plurality of sections, and the type of decision linked with the total performance score and the risk index may be determined by each section. For example, the type of decision may be determined as shown in FIG. 8.

FIG. 8 is a view illustrating a decision method performed in a process of performing decision-making shown in FIG. 2. Four types of decisions may be derived. Specifically, all values that the total performance score can have may be divided into three sections, high, medium, and low, and all values that the risk index can have may be divided into three sections, high, medium, and low. Thereafter, the type of decision linked with the total performance score and the risk index may be determined by each section.

For example, a type A in which the risk index corresponds to the high section and the total performance score corresponds to the medium and low sections may have low performance and low risk, and a decision may be derived so as not to progress to a next stage. In the type A, the decision may be performed such that redesign is wholly or partially performed based on the risk reduction and avoidance activities in the corresponding stage. The target may be indicated to correspond to an item in which the performance score is less than a criterion or relatively low.

Also, a type B in which the risk index corresponds to the high section and the total performance score corresponds to the high section may have a high risk index anda high performance score, and the decision may be derived so as to wholly perform the risk reduction and avoidance activities. In the type B, maintaining of an existing performance may become a fundamental correspondence activity evaluation criterion.

Also, a type C in which the risk index corresponds to the medium or low section and the total performance score corresponds to the low section may have low risk index and low performance score, and the decision may be performed so as to perform reworking for increasing performance. In the type C, strategy may be proposed so as to develop various design-improving activities.

Also, a type D in which the risk index corresponds to the medium or low section and the total performance score corresponds to the medium or high section may have a proper performance score or more and a proper risk index or less, and the decision may be derived to progress to a next stage in the next process.

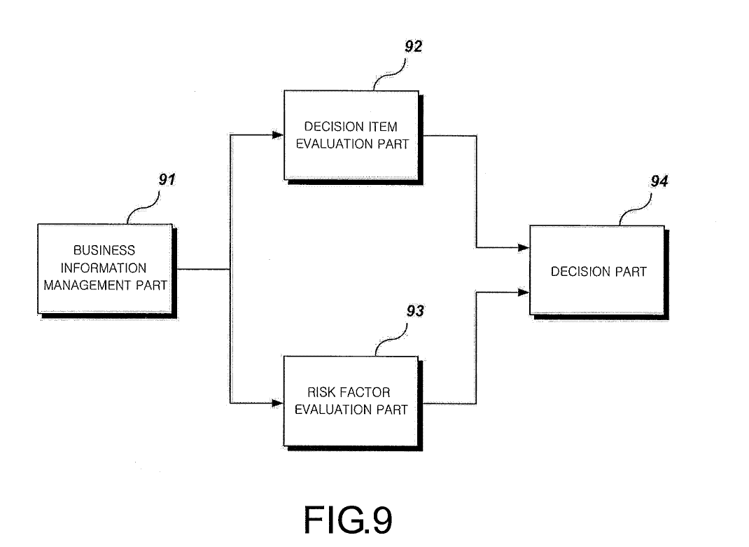

The decision support method for the project management of the LNG plant may be performed by a system as shown in FIG. 9.

Referring to FIG. 9, a decision support system for project management of an LNG plant according to an embodiment of the present invention may include a business information management part 91, a decision item evaluation part 92, a risk factor evaluation part 93, and a decision part 94.

The business information management part 91 may determine a plurality of stages corresponding to sequential processes performed for the project management of the LNG plant, and risk factors with respect to decision items necessary to perform the plurality of stages and the plurality of stages.

As described in the detailed description of the decision support method for the project management of the LNG plant, operations S11 and S12 may be performed by the business information management part 91. Also, the determining of the risk factor in operation S14 may be performed by the business information management part 91. Particularly, the business information management part 91 may determine the decision items based on the compatibility with strategic goals, the compatibility with investment return goals, the compatibility with safety standards, and the compatibility with quality standards in operation S12.

The decision item evaluation part 92 may estimate individual performance scores with respect to the decision items determined by the business information management part 91, and may derive the total performance scores with respect to the plurality of stages using the individual performance scores. As described in the detailed description of the decision support method for the project management of the LNG plant, operation S12 may be performed by the decision item evaluation part 92.

Specifically, the decision item evaluation part 92 may calculate the individual performance scores including the strategy score assigned to the decision item related to the compatibility with the strategic goal, the cost score assigned to the decision item related to the compatibility with the investment returns goal, the safety score assigned to the decision item related to the compatibility with the safety standards, and the quality score assigned to the decision item related to the compatibility with the quality standards. Also, the decision item evaluation part 92 may determine a value obtained by multiplying the arithmetic mean values of the strategy scores, the cost scores, the safety scores, and the quality scores by a predetermined importance index and adding them together as the total performance score.

The risk factor evaluation part 93 may evaluate the risk factor determined by the business information management part 91 to derive the risk indexes with respect to the stages. The risk factor evaluation part 93 may perform operation S14 as described in the detailed description of the decision support method for the project management of the LNG plant.

As described in the detailed description of the decision support method for the project management of the LNG plant, the PI score may be calculated by Equation (1), and the risk index may be calculated in accordance with the PI score.

The decision part 94 may perform a decision with respect to a corresponding stage according to the total performance score and the risk index derived with respect to the plurality of stages.

The decision part 94 may divide all values that the total performance score and the risk index can have into a plurality of sections, and may determine the types of decision linked with the total performance score and the risk index. As described above, the types of decision linked with the total performance score and the risk index are shown in FIG. 8.

Also, the decision part 94 may perform a decision with respect to a corresponding stage according to the sections to which the total performance score derived by the decision item evaluation part 92 and the risk index derived by the risk factor evaluation part 93 belong.

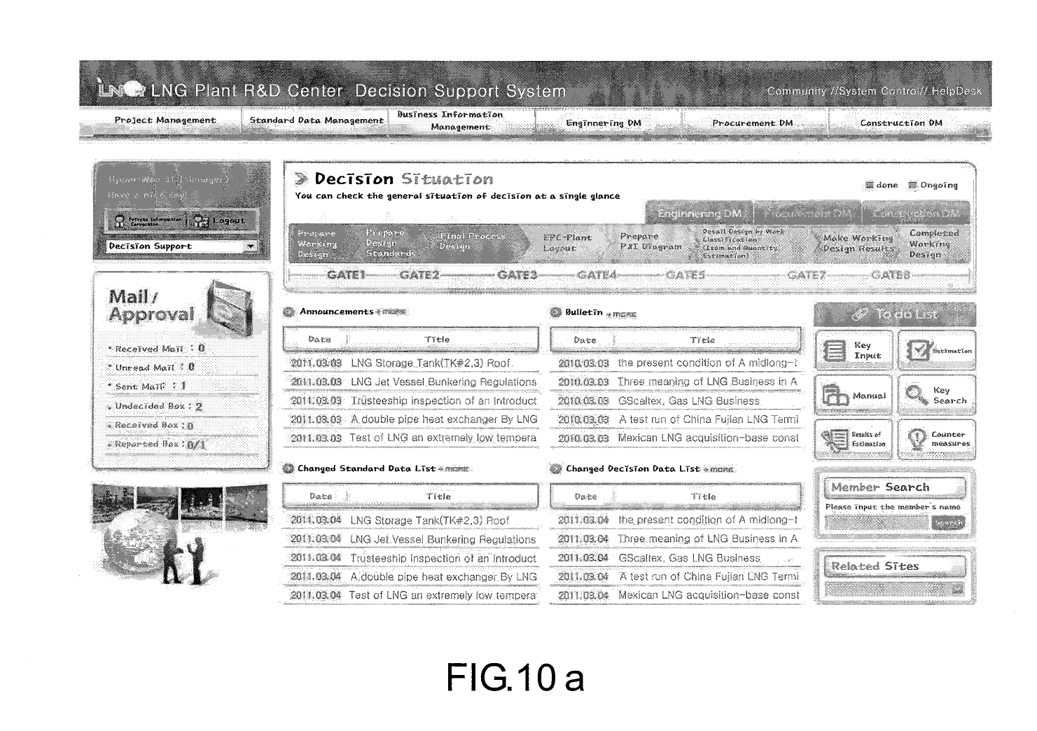

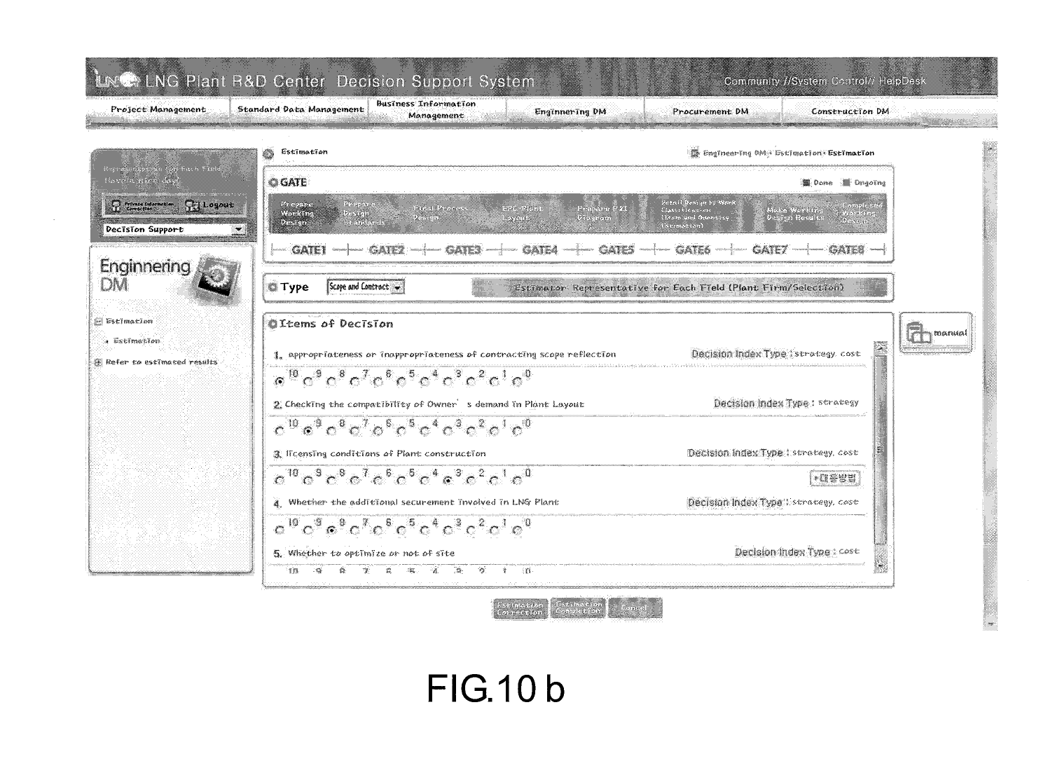

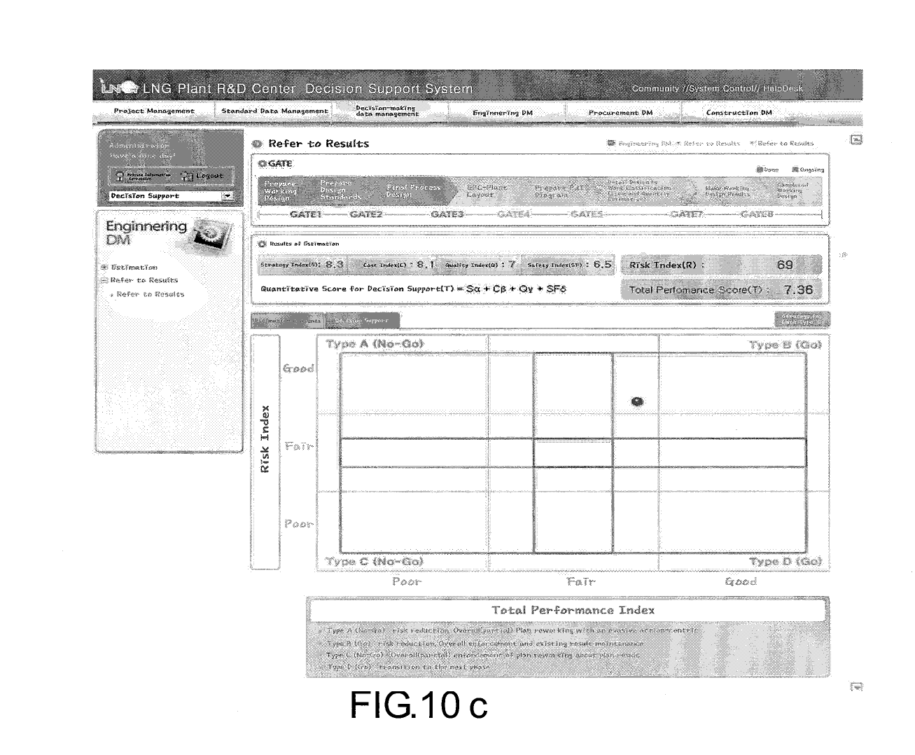

FIGS. 10a through 10c are views illustrating web screens of a decision support system for project management of an LNG plant according to an embodiment of the present invention.

FIG. 10a illustrates a main screen of the decision support system for the project management of the LNG plant. The configuration of the main screen may be extended to support a decision of overall LNG plant business such as purchase & procurement, construction, and test run which are expected to be developed in the future, in addition to development of the system up to the engineering stage. In order for a decision-maker to manage a plurality of projects, the function of selecting projects and the present state of a decision on the projects may be disposed at the center of the main screen for better visual recognition. Also, the official announcement, the notice, and the information changes may be listed at the central portion of the main screen for easier access to information.

FIG. 10b illustrates an evaluation screen of the decision support system for the project management of the LNG plant. The evaluation of decision support may include evaluation of a unit engineer on authorized items, evaluation of a person in charge of each category, and final evaluation of a person in charge of an overall project. If the evaluation is completed, decision support information of a corresponding gate can be verified.

FIG. 10c illustrates a reference screen of evaluation results. The evaluation results may be verified by a gate, and the risk management index and the evaluation contents may be verified.

According to an embodiment of the present invention, an alternative with a structured system can be derived and a decision structure based on risk can be achieved by combining logical decision structure and procedure of the business performance process in a project management decision support system for an LNG plant business. According to an embodiment of the present invention, general project management ability can be supplemented and design and construction errors and reworking can be minimized, by supporting a decision using a stage-gate model in which a point when decision is necessary is defined as a gate in EPC project management for an LNG plant business. According to an embodiment of the present invention, a decision support method for EPC project management of the LNG plant business can be expanded from the design stage to purchase & procurement and construction stages in the future to be utilized for development of a whole EPC decision support system necessary for EPC project management of the LNG plant.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A decision support method for project management of a liquefied natural gas (LNG) plant, comprising:
determining a plurality of stages corresponding to sequential processes performed for Engineering, Procurement & Construction (EPC) project management of the LNG plant;
determining decision items necessary to perform the plurality of stages;
estimating individual performance scores with respect to the decision items and deriving a total performance score with respect to each of the plurality of stages using the individual performance scores;
determining risk factors with respect to each of the plurality of stages and deriving risk indexes with respect to each of the plurality of stages by evaluating the risk factors; and
performing decision-making with respect to a corresponding stage according to the total performance score and the risk index derived with respect to each of the plurality of stages.

2. The decision support method of claim 1, wherein the determining of the decision items comprises determining the decision items based on compatibility with strategic goals, compatibility with investment return goals, compatibility with safety standards, and compatibility with quality standards.

3. The decision support method of claim 2, wherein the individual performance scores comprise a strategy score assigned to the decision item related to the compatibility with the strategic goal, a cost score assigned to the decision item related to the compatibility with the investment returns goal, a safety score assigned to the decision item related to the compatibility with the safety standards, and a quality score assigned to the decision item related to the compatibility with the quality standards.

4. The decision support method of claim 3, wherein the deriving of the total performance score comprises determining a value obtained by multiplying arithmetic mean values of the strategy scores, the cost scores, the safety scores, and the quality scores by predetermined importance indexes and adding them together as the total performance score.

5. The decision support method of claim 1, wherein the determining of the risk factors comprises determining the risk factors using a PI score that is a relative priority of a risk estimated using probability and impact of the risk factor.

6. The decision support method of claim 5, wherein the PI score is \sqrt{P²+I²}, where P denotes the probability of the risk factor, I denotes the impact of the risk factor, and the risk index is determined in accordance with the PI score.

7. The decision support method of claim 1, wherein the performing of the decision-making comprises:
dividing all values that the total performance score and the risk index have into a plurality of sections and determining a type of decision linked to the total performance score and the risk index for each section; and
performing a type of a decision determined with respect to a section to which the total performance score derived in the deriving of the total performance score and the risk index derived in the determining of the risk factors belong.

8. The decision support method of claim 7, wherein the determining of the type of decision comprises:
dividing all values that the total performance score has and all values that the risk index has into first to third sections having a uniform size, wherein the total performance score or the risk index is reduced from the first section to the third section;
making a decision to rework a corresponding stage when the total performance score corresponds to the second section or the third section and the risk index corresponds to the first section;
making a decision to perform risk reduction and avoidance activities when the total performance score corresponds to the first section and the risk index corresponds to the first section;
making a decision to perform reworking on design performance when the total performance score corresponds to the third section and the risk index corresponds to the second section or the third section; and
making a decision to progress to a next stage in sequential processes when the total performance score corresponds to the first section or the third section and the risk index corresponds to the second section or the third section.

9. A decision support system for project management of a liquefied natural gas (LNG) plant, comprising:
a business information management part configured to determine a plurality of stages corresponding to sequential processes performed for Engineering, Procurement & Construction (EPC) project management of the LNG plant, decision items necessary to perform each of the plurality of stages, and risk factors with respect to each of the plurality of stages;
a decision item evaluation part configured to estimate individual performance scores with respect to the decision items and derive a total performance score with respect to each of the plurality of stages using the individual performance scores;
a risk factor evaluation part configured to derive risk indexes with respect to each of the plurality of stages by evaluating the risk factors; and
a decision part configured to perform decision-making with respect to a corresponding stage according to the total performance score and the risk index derived with respect to each of the plurality of stages.

10. The decision support system of claim 9, wherein the business information management part determines the decision items based on compatibility with strategic goals, compatibility with investment return goals, compatibility with safety standards, and compatibility with quality standards

11. The decision support system of claim 10, wherein the individual performance scores comprise a strategy score assigned to the decision item related to the compatibility with the strategic goal, a cost score assigned to the decision item related to the compatibility with the investment returns goal, a safety score assigned to the decision item related to the compatibility with the safety standards, and a quality score assigned to the decision item related to the compatibility with the quality standards.

12. The decision support system of claim 11, wherein the decision item evaluation part determines a value obtained by multiplying arithmetic mean values of the strategy scores, the cost scores, the safety scores, and the quality scores by predetermined importance indexes and adding them together as the total performance score.

13. The decision support system of claim 9, wherein the risk factor evaluation part determines the risk factors using a PI score that is a relative priority of a risk estimated using probability and impact of the risk factor.

14. The decision support system of claim 13, wherein the PI score is \sqrt{P²+I²}, where P denotes the probability of the risk factor, I denotes the impact of the risk factor, and the risk index is determined in accordance with the PI score.

15. The decision support system of claim 9, wherein the decision part:
divides all values that the total performance score and the risk index have into a plurality of sections and determines a type of decision linked to the total performance score and the risk index for each section; and
performs decision-making with respect to a corresponding state according to a section to which the total performance score derived from the decision item and the risk index derived by the risk factor evaluation part belong.

16. The decision support system of claim 15, wherein the decision part:
divides all values that the total performance score has and all values that the risk index has into first to third sections having a uniform size, wherein the total performance score or the risk index is reduced from the first section to the third section;
makes a decision to rework a corresponding stage when the total performance score corresponds to the second section or the third section and the risk index corresponds to the first section;
makes a decision to perform risk reduction and avoidance activities when the total performance score corresponds to the first section and the risk index corresponds to the first section;
makes a decision to perform reworking on design performance when the total performance score corresponds to the third section and the risk index corresponds to the second section or the third section; and
makes a decision to progress to a next stage in sequential processes when the total performance score corresponds to the first section or the third section and the risk index corresponds to the second section or the third section.
